(19) United States
(12) Patent Application Publication
(10) Pub. No.: US 2026/0030219 A1
(43) Pub. Date: Jan. 29, 2026

(54) FILE SYSTEM METADATA STORAGE

(71) Applicant: Micron Technology, Inc., Boise, ID (US)

(72) Inventors: Chaohui Liu, Shanghai (CN); Liang GE, Shanghai (CN)

(21) Appl. No.: 19/278,127

(22) Filed: Jul. 23, 2025

Related U.S. Application Data
(60) Provisional application No. 63/676,291, filed on Jul. 26, 2024.

(51) Int. Cl. G06F 16/18; G06F 12/02; G06F 16/16

(52) U.S. Cl. CPC G06F 16/1847; G06F 12/0246; G06F 16/164

(57) ABSTRACT

Methods, systems, and devices for file system metadata storage are described. A memory system may receive an indication, from a host system, of a region of a file system associated with storage of metadata. The memory system may receive commands to write metadata to the file system, and the memory system may determine whether the data is metadata based on whether the logical block address (LBA) to be written falls within the metadata region. The memory system may identify metadata and write the metadata using a first quantity of bits per memory cell, which may be less than a quantity of bits per memory cell that the memory system supports. In response to the memory system receiving a request to read data, the memory system may identify that the data is metadata and may access the data from memory cells that support the first quantity of bits per memory cell.

### CROSS REFERENCE

The present Application for Patent claims priority to U.S. Patent Application No. 63/676,291 by Liu et al., entitled “FILE SYSTEM METADATA STORAGE,” filed Jul. 26, 2024, which is assigned to the assignee hereof, and which is expressly incorporated by reference in its entirety herein.

### TECHNICAL FIELD

The following relates to one or more systems for memory, including file system metadata storage.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports file system metadata storage in accordance with examples as disclosed herein.

FIG. 2 shows an example of an architecture that supports file system metadata storage in accordance with examples as disclosed herein.

FIG. 3 shows an example of a process that supports file system metadata storage in accordance with examples as disclosed herein.

FIG. 4 shows a block diagram of a memory system that supports file system metadata storage in accordance with examples as disclosed herein.

FIG. 5 shows a block diagram of a host system that supports file system metadata storage in accordance with examples as disclosed herein.

FIGS. 6 and 7 show flowcharts illustrating a method or methods that support file system metadata storage in accordance with examples as disclosed herein.

### DETAILED DESCRIPTION

Some computing systems may implement a file system (e.g., a flash-friendly file system (F2FS)) for storing system data and user data. The file system may include metadata, which may indicate areas of the file system used for various types of data. The metadata may include information pertaining to how the file system is organized or configured, and the metadata may be used for managing the file system. The metadata may be frequently accessed relative to other data stored in the file system. However, data for the file system may be stored on a memory system which may be unable to identify the types of data being accessed. The memory system may be capable of writing data to multiple levels of quantities of bits per memory cell, which may support an increased data storage capacity at the memory system. By default, the memory system may write any data it receives, including metadata, using a first quantity of bits per memory cell (e.g., triple level cells (TLCs), quad-level cells (QLCs)), which may be associated with a relatively high latency. Thus, in response to the memory system reading the data from the first type of memory cells, the memory system may experience delays due to the metadata being stored in the first type of memory cells associated with relatively low access speeds.

In accordance with examples described herein, a memory system may receive an indication, from a host system, of the region of the file system (e.g., a range of logical block addresses (LBAs)) associated with storage of metadata. The memory system may receive commands to write metadata to the file system, and the memory system may determine whether the data is metadata based on whether the LBA to be written falls within the configured metadata region. The memory system may identify metadata and write (e.g., pin) the metadata using a second quantity of bits per memory cell (e.g., single-level cells (SLCs), multi-level cells (MLCs)), which may be less than other quantities of bits per memory cell (e.g., the first quantity of bits per memory cell) that the memory system uses to write other data (e.g., user data). In response to the memory system receiving a request to read data, the memory system may identify that the requested data is metadata and access the data from memory cells within the memory system that support the first quantity of bits per memory cell (e.g., SCLs, MLCs), which may increase memory access speeds.

In addition to applicability in memory systems as described herein, techniques for file system metadata storage may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds for access of metadata within a file system, which may decrease processing or latency times, improve response times, or otherwise improve user experience, among other benefits.

Features of the disclosure are illustrated and described in the context of systems, devices, and circuits. Features of the disclosure are further illustrated and described in the context of architectures and flowcharts.

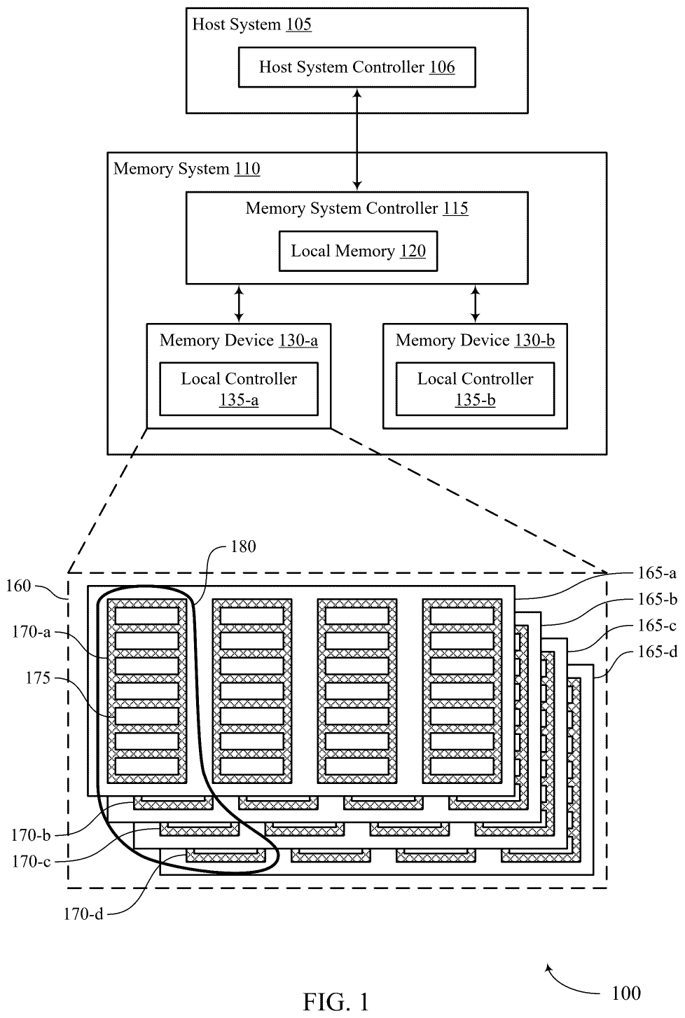

FIG. 1 shows an example of a system 100 that supports file system metadata storage in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as SLCs. Additionally, or alternatively, a NAND memory device 130 may include memory cells configured to each store multiple bits of information, which may be referred to as MLCs if configured to each store two bits of information, as TLCs if configured to each store three bits of information, as QLCs if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 (e.g., a superblock) may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

Some computing systems (e.g., a system 100) may implement a file system (e.g., an F2FS) for storing system data and user data. The file system may include metadata, which may indicate areas of the file system used for various types of data. The metadata may include information pertaining to how the file system is organized or configured, and the metadata may be used for managing the file system. The metadata may be frequently accessed relative to other data stored in the file system. However, data for the file system may be stored on a memory system 110 which may be unable to identify the types of data being accessed. The memory system 110 may be capable of writing data to multiple levels of quantities of bits per memory cell, which may support an increased data storage capacity at the memory system 110. By default, the memory system 110 may write any data it receives, including metadata, using a first quantity of bits per memory cell (e.g., triple level cells (TLCs), quad-level cells (QLCs)), which may be associated with a relatively high latency. Thus, in response to the memory system 110 reading the data from the first type of memory cells, the memory system 110 may experience delays due to the metadata being stored in the first type of memory cells associated with relatively low access speeds.

In accordance with examples described herein, a memory system 110 may receive an indication, from a host system 105, of the region of the file system (e.g., a range of logical block addresses (LBAs)) associated with storage of metadata. The memory system 110 may receive commands to write metadata to the file system, and the memory system 110 may determine whether the data is metadata based on whether the LBA to be written falls within the configured metadata region. The memory system 110 may identify metadata and write (e.g., pin) the metadata using a second quantity of bits per memory cell (e.g., single-level cells (SLCs), multi-level cells (MLCs)), which may be less than other quantities of bits per memory cell (e.g., the first quantity of bits per memory cell) that the memory system 110 uses to write other data (e.g., user data). In response to the memory system receiving a request to read data, the memory system may identify that the requested data is metadata and access the data from memory cells within the memory system 110 (e.g., memory devices 130) that support the first quantity of bits per memory cell (e.g., SCLs, MLCs), which may increase memory access speeds.

The system 100 may include any quantity of non-transitory computer readable media that support file system metadata storage. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

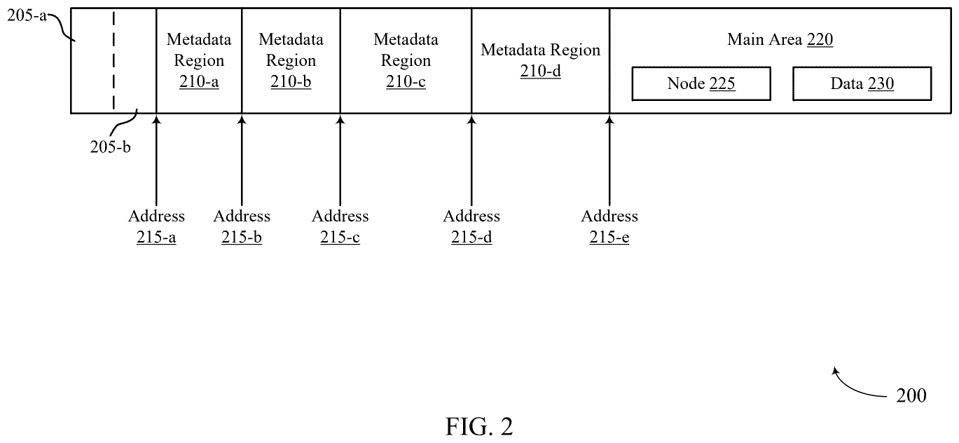

FIG. 2 shows an example of an architecture 200 that supports file system metadata storage in accordance with examples as disclosed herein. The architecture 200 may implement or may be implemented by aspects of the system 100, as described with reference to FIG. 1. For example, the architecture 200 may be implemented within a file system of a memory system 110 (e.g., a memory system controller 115), as described with reference to FIG. 1.

In some examples, a subset of data (e.g., information) within the file system may indicate partition information for the file system. The partition information may indicate an underlying structure (e.g., organization) of the file system or may indicate respective locations of fields or data regions. In some cases, the partition information may indicate a first range of LBAs corresponding to storage of metadata (e.g., in metadata regions 210) within the file system and a second range of LBAs corresponding to storage of user data (e.g., in a main area 220) within the file system. In an illustrative example, the partition information may indicate an address 215-a, which may be a starting address (e.g., a starting LBA) of a metadata region 210-a, an address 215-b, which may be a starting address of a metadata region 210-b, an address 215-c, which may be a starting address of a metadata region 210-c, an address 215-d, which may be a starting address of a metadata region 210-d, and an address 215-c, which may be a starting address of a main area 220 of the file system. In some examples, the partition information may be indicated via one or more superblocks 205. For example, the file system may include a superblock 205-a and a superblock 205-b, each of which may store a redundant copy of the partition information.

The metadata regions 210 may store metadata associated with the file system. The metadata may include information pertaining to an organization or configuration of the file system (e.g., how the file system is set up). The metadata may include data to manage and/or store an indication of where user data is located within the main area 220. The metadata regions 210 may precede the main area 220 in the file system. For example, the metadata regions 210 may be associated with one or more LBAs that precede LBAs associated with the main area 220. The metadata may be partitioned into a quantity (e.g., four) metadata regions 210. In an illustrative example (e.g., in a F2FS), the metadata region 210-a may be a checkpoint (CP), the metadata region 210-b may be a segment information table (SIT), the metadata region 210-c may be a node address table (NAT), and the metadata region 210-d may be a segment summary area (SSA). It is to be understood that the metadata may be partitioned into any quantity of metadata regions 210, and the metadata regions 210 may be varied in type or in information that the metadata region 210 stores.

The main area 220 may store user data received from a host system (e.g., and designated for storage in the file system). The main area 220 may be made up of a quantity of blocks (e.g., non-volatile blocks). Each block of the quantity of blocks may be allocated to store a node 225 or data 230. A node 225 (e.g., a node block) may include an index node (e.g., inode) or indices of data blocks. Data 230 (e.g., a data block) may include directory data or user file data. In some examples, a memory system may receive data for storage in the file system, and the data may be metadata (e.g., for storage in a metadata region 210) or user data (e.g., for storage in the main area 220). However, the memory system may be unaware of which LBAs within the file system store metadata and which LBAs store user data. Thus, the memory system may store any data received in a first type of memory cell (e.g., TLC, QLC) using a first quantity of bits per memory cell, which may be a maximum quantity of bits per memory cell that the memory system supports. For example, some memory systems may support QLCs (e.g., four bits per cell) whereas other memory systems may support TLCs (e.g., three bits per cell) as the maximum quantity of bits per cell. The metadata within the metadata regions 210 may be accessed at a higher frequency relative to user data within the main area 220.

To support faster access speeds of the metadata of the metadata regions 210, the memory system (e.g., a memory system 110) may receive an indication, from a host system (e.g., a host system 105), of the region of the file system (e.g., a range of LBAs spanning the metadata regions 210, one or more starting addresses 215 corresponding to metadata regions 210) associated with storage of metadata. For example, the host system may (e.g., during a mounting operation of the memory system) obtain (e.g., via at least one superblock 205 of the file system) the partition information (e.g., one or more properties of the file system) that indicates the addresses 215 (e.g., the address 215-a, the address 215-b, the address 215-c, the address 215-d, the address 215-c). In response to obtaining the partition information, the host system may determine a set of LBAs for storing the metadata, and the host system may transmit an indication of the set of LBAs for storing metadata to the memory system.

The memory system may receive commands to write metadata to the file system, and the memory system may determine whether the data is metadata based on whether the associated LBA falls within a configured metadata region 210 (e.g., within a range of LBAs associated with the metadata region 210). The memory system may identify metadata and write (e.g., pin) the metadata using a first quantity of bits per memory cell (e.g., SLCs, MLCs) which is less than other quantities of bits per memory cell (e.g., TLC, QLC) that the memory system uses to store other data (e.g., user data corresponding to the main area 220). For example, if a memory system supports QLCs, the metadata may be written to SLCs, MLCs, or TLCs, whereas if the memory system supports only TLCs, the metadata may be written to SLCs or MLCs.

Additionally, or alternatively, the memory system may identify that the data is user data. For example, the memory system may determine that the LBA to be written falls outside of the configured range of LBAs for metadata. Additionally, or alternatively, the memory system may determine that the LBA falls within different range of LBAs for storing user data (e.g., in accordance with a second range of LBAs spanning the main area 220 or a starting address 215-e corresponding to the main area 220). In response to the memory system identifying that the data is user data, the memory system may write the user data to the main area 220. The memory system may write the user data to the main area 220 using a second quantity of bits per memory cell that is greater than the first quantity of bits per memory cell.

In response to the memory system receiving a request to read data, the memory system may determine whether an LBA of the data is within the range of LBAs for storing metadata or is outside of the range of LBAs for storing metadata (e.g., is within a second range of LBAs for storing user data). If the memory system identifies that the requested data to be read is metadata, the memory system may access the data from memory cells within the file system that support the first quantity of bits per memory cell, which may increase memory access speeds.

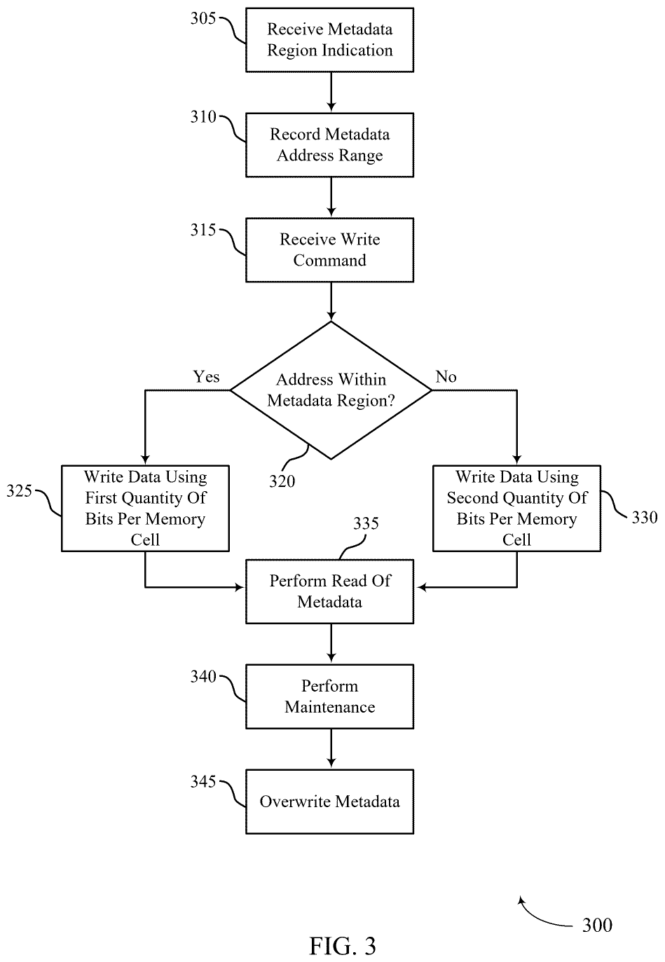

FIG. 3 shows an example of a process 300 that supports file system metadata storage in accordance with examples as disclosed herein. The process 300 may implement aspects or operations of a system, which may be an example of a system 100, as described with reference to FIG. 1. For example, the process 300 may be implemented by a memory system, which may be an example of a memory system 110. In some cases, the process 300 may be facilitated by a memory system controller, which may be an example of a memory system controller 115. The process 300 may illustrate file system metadata storage operations associated with allocation of the metadata into lower latency memory cells, which may support improved memory access speeds of the metadata.

In the following description of the process 300, the methods, techniques, processes, and operations may be performed in different orders or at different times. Further, some operations may be left out of the process 300, or other operations may be added to the process 300. Aspects of the process 300 may be implemented by one or more controllers, among other components. Additionally, or alternatively, aspects of the process 300 may be implemented as instructions stored in one or more memories (e.g., volatile memory, non-volatile memory). For example, the instructions, when executed by one or more controllers (e.g., the memory system controller 115), may cause the one or more controllers (or a device or a system) to perform the operations of the process 300.

At 305, an indication of a set of LBAs for storing metadata (e.g., a metadata region 210) may be received. For example, a memory system (e.g., a memory system 110, a memory system controller 115) may receive the indication from a host system (e.g., a host system 105). The metadata may be associated with management of a file system. The indication of the set of LBAs for storing metadata may include multiple starting LBAs (e.g., address 215-a, address 215-b, address 215-c, address 215-d) for respective data regions (e.g., metadata regions 210, CP, SIT, NAT, SSA) of a set of data regions stored within the file system. The memory system may receive a vendor-unique (VU) command, an attribute, a flag, or a combination thereof, that indicates the set of LBAs. In some examples, the indication of the set of LBAs may be a range of contiguous LBAs for storing metadata.

Additionally, or alternatively, a region of LBAs for storing user data (e.g., in a main area 220) may be received. For example, the memory system may receive, from the host system, an indication of a region of LBAs (e.g., a set of LBAs, a contiguous range of LBAs) for storing user data (e.g., a main area 220). In some cases, the region of LBAs for storing user data may be indicated according to a starting address (e.g., an address 215-c of a main area (e.g., a main area 220) of the file system. The region of LBAs for storing user data may be non-overlapping with the set of LBAs for storing metadata.

At 310, the set of LBAs for storing metadata, the region of LBAs for storing user data, or both, may be stored. For example, the memory system (e.g., a memory system 110, a memory system controller 115) may store the set of LBAs for storing metadata, the region of LBAs for storing user data, or both, in memory (e.g., a memory device 130 or local memory 120). In some cases, the set of LBAs for storing metadata, the region of LBAs for storing user data, or both, may be stored in volatile memory, in non-volatile memory, or a combination thereof.

At 315, a command associated with writing data to a first LBA may be received. For example, the memory system (e.g., a memory system 110, a memory system controller 115) may receive the command from a host system (e.g., a host system 105). The write command may be received after receiving the indication of the set of LBAs for storing metadata, or after receiving the indication of the region of LBAs for storing user data, or both.

At 320, the memory system (e.g., a memory system 110, a memory system controller 115) may determine whether the first LBA is included in the set of LBAs for storing metadata. The memory system may include one or more arrays of memory cells that may be operable to store data using one of a set of multiple quantities of bits per memory cell (e.g., the one or more arrays of memory cells may include SLC, MLC, TLC, and/or QLC). At 325, in response to determining that the first LBA is included in the set of LBAs for storing metadata, the memory system (e.g., a memory system 110, a memory system controller 115) may write the data to a first set of memory cells (e.g., SLC, MLC) in accordance with a first quantity of bits per memory cell (e.g., one bit per memory cell, two bits per memory cell). In some examples, writing the data (e.g., metadata) to the first set of memory cells (e.g., SLC, MLC) may include pinning the data to the first set of memory cells. For example, writing the data (e.g., metadata) to the first set of memory cells may include updating an L2P table to indicate that the LBA being written is mapped to the first set of memory cells (e.g., and will not be moved for a duration). Additionally, or alternatively, the data may be written with an indication (e.g., a tag, a label) that the data is to be written using the first quantity of bits per memory cell, and any operations (e.g., moves, garbage collection, refresh) performed on the data may be in accordance with the indication.

At 330, in response to determining that the first LBA is included in the region of LBAs for storing user data (e.g., or determining the first LBA is not included in the set of LBAs for storing metadata), the memory system (e.g., a memory system 110, a memory system controller 115) may write the data to a second set of memory cells (e.g., TLC, QLC) in accordance with a second quantity of bits per memory cell (e.g., three bits per memory cell, four bits per memory cell) that is greater than the first quantity of bits per memory cell for writing the metadata (e.g., at 325). For example, the memory system may write the data directly to a second set of memory cells, whereas other types of data (e.g., user data) may be written to a first set of memory cells (e.g., SLCs) and later moved (e.g., folded) to a second set of memory cells (e.g., TLCs, QLCs). At 335, metadata may be read from the first LBA. For example, the memory system (e.g., a memory system 110, a memory system controller 115) may receive a command from the host system (e.g., a host system 105) to read the data stored to the first LBA. The memory system may transmit, responsive to receiving the command, the data from the first set of memory cells (e.g., SLC, MLC). By reading the metadata from the first set of memory cells, which correspond to a fewer quantity of bits per memory cell relative to the second set of memory cells (e.g., where user data is stored in the file system), the memory system may support increased access speeds of the metadata.

At 340, a maintenance operation may be performed on the metadata in the file system. For example, the memory system (e.g., a memory system 110, a memory system controller 115) may move, after writing the metadata to the first set of memory cells and as part of a maintenance operation (e.g., a refresh operation, a garbage collection operation), the data from the first set of memory cells (e.g., a first physical address) to a third set of memory cells (e.g., a second physical address) associated with the set of LBAs (e.g., metadata region 210). The first set of memory cells and the third set of memory cells may include memory cells of a same memory cell type (e.g., SLC, MLC). The memory system may write the data to the third set of memory cells using the first quantity of bits per memory cell (e.g., one bit per memory cell, two bits per memory cell). The memory system may update a L2P mapping such that the first LBA is mapped to the third set of memory cells in response to moving the data. The first set of memory cells may be released (e.g., freed, unmapped, made available) in response to moving the data.

At 345, the metadata stored in the first LBA may be overwritten. For example, the memory system (e.g., a memory system 110, a memory system controller 115) may receive, from the host system (e.g., a host system 105), third data associated with the first LBA (e.g., mapped to the first LBA in accordance with an L2P mapping) after the memory system receives the data and writes the data to the first set of memory cells (e.g., a first physical address). The memory system may write the third data to a fourth set of memory cells (e.g., a second physical address) in accordance with the first quantity of bits per memory cell (e.g., one bit per memory cell, two bits per memory cell) in response to determining that the first LBA is included in the set of LBAs. The first set of memory cells and the fourth set of memory cells may include memory cells of a same memory cell type (e.g., SLC, MLC). The memory system may erase the data from the first set of memory cells in response to writing the third data to the fourth set of memory cells. The memory system may update an L2P mapping such that the first LBA is mapped to the fourth set of memory cells in response to writing the third data to the fourth set of memory cells and erasing the data from the first set of memory cells. The first set of memory cells may be released (e.g., freed, unmapped, made available) in response to overwriting the metadata stored in the first LBA.

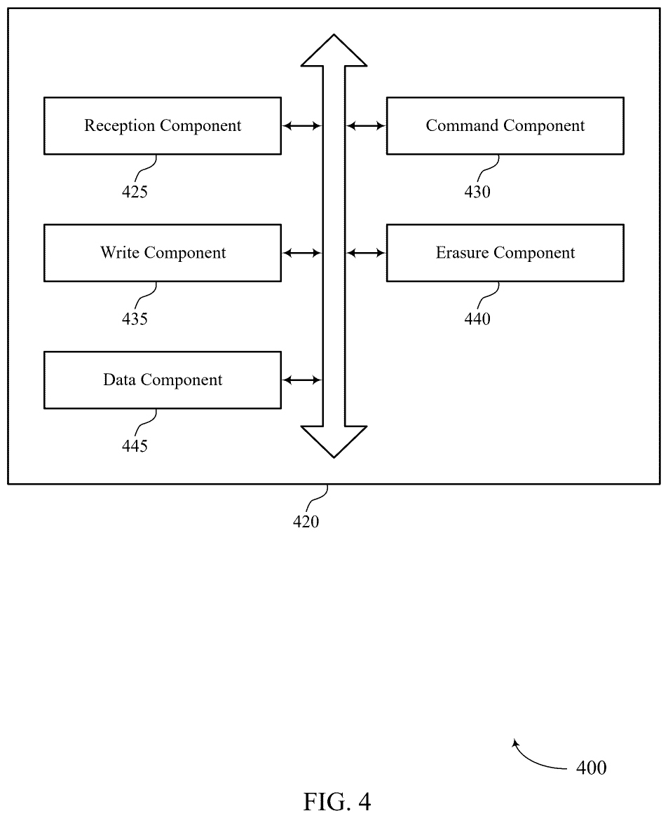

FIG. 4 shows a block diagram 400 of a memory system 420 that supports file system metadata storage in accordance with examples as disclosed herein. The memory system 420 may be an example of aspects of a memory system as described with reference to FIGS. 1 through 3. The memory system 420, or various components thereof, may be an example of means for performing various aspects of file system metadata storage as described herein. For example, the memory system 420 may include a reception component 425, a command component 430, a write component 435, an erasure component 440, a data component 445, or any combination thereof. Each of these components, or components of subcomponents thereof (e.g., one or more processors, one or more memories), may communicate, directly or indirectly, with one another (e.g., via one or more buses).

The reception component 425 may be configured as or otherwise support a means for receiving an indication of a set of LBAs for storing metadata associated with management of a file system, where the memory system includes one or more arrays of memory cells that are operable to store data using one of a plurality of quantities of bits per memory cell, where the plurality of quantities of bits per memory cell includes a first quantity of bits per memory cell and a second quantity of bits per memory cell greater than the first quantity. The command component 430 may be configured as or otherwise support a means for receiving a command associated with writing data to a first LBA after receiving the indication of the set of LBAs for storing metadata. The write component 435 may be configured as or otherwise support a means for writing the data to a first set of memory cells in accordance with the first quantity of bits per memory cell in response to determining that the first LBA is included in the set of LBAs.

In some examples, the indication of the set of LBAs indicates a plurality of starting LBAs for respective data regions of a plurality of data regions associated with the file system.

In some examples, the plurality of data regions associated with the file system includes a first data region associated with a checkpoint, a second data region associated with a segment information table, a third data region associated with a node address table, and a fourth data region associated with a segment summary area.

In some examples, the reception component 425 may be configured as or otherwise support a means for receiving an indication of a region of LBAs for storing user data.

In some examples, the command component 430 may be configured as or otherwise support a means for receiving, after receiving the indication of the region of LBAs for storing user data, a command associated with writing second data to a second LBA within the region of LBAs for storing user data. In some examples, the write component 435 may be configured as or otherwise support a means for writing the second data to a second set of memory cells in accordance with the second quantity of bits per memory cell in response to receiving the command and receiving the indication of the region of LBAs for storing user data.

In some examples, to support receiving the indication of the set of LBAs, the reception component 425 may be configured as or otherwise support a means for receiving a vendor-unique command, an attribute, a flag, or a combination thereof, indicating the set of LBAs.

In some examples, to support writing the data to the first set of memory cells, the write component 435 may be configured as or otherwise support a means for writing the data to the first set of memory cells using one bit per memory cell or two bits per memory cell.

In some examples, to support receiving the indication of the set of LBAs for storing metadata, the reception component 425 may be configured as or otherwise support a means for receiving an indication of a range of contiguous LBAs for storing metadata.

In some examples, the write component 435 may be configured as or otherwise support a means for moving, after writing the metadata to the first set of memory cells and as part of a maintenance operation, the data from the first set of memory cells to a third set of memory cells associated with the set of LBAs, where the data is written to the third set of memory cells using the first quantity of bits per memory cell.

In some examples, the reception component 425 may be configured as or otherwise support a means for receiving third data associated with the first LBA after receiving the data. In some examples, the write component 435 may be configured as or otherwise support a means for writing the third data to a fourth set of memory cells in accordance with the first quantity of bits per memory cell in response to determining that the first LBA is included in the set of LBAs. In some examples, the erasure component 440 may be configured as or otherwise support a means for erasing the data from the first set of memory cells in response to writing the third data to the fourth set of memory cells.

In some examples, the command component 430 may be configured as or otherwise support a means for receiving a command to read the data stored to the first LBA. In some examples, the data component 445 may be configured as or otherwise support a means for transmitting, responsive to the command, the data from the first set of memory cells.

In some examples, the file system is a F2FS.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

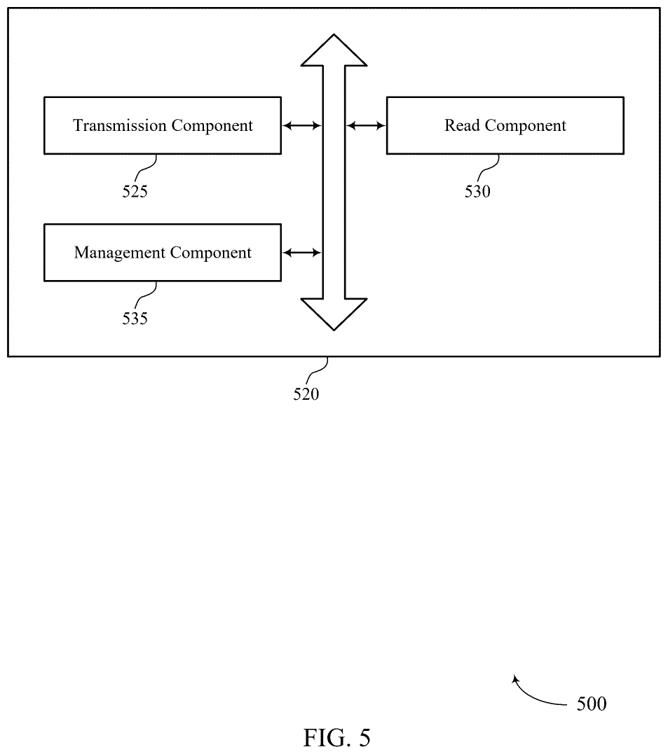

FIG. 5 shows a block diagram 500 of a host system 520 that supports file system metadata storage in accordance with examples as disclosed herein. The host system 520 may be an example of aspects of a host system as described with reference to FIGS. 1 through 3. The host system 520, or various components thereof, may be an example of means for performing various aspects of file system metadata storage as described herein. For example, the host system 520 may include a transmission component 525, a read component 530, a management component 535, or any combination thereof. Each of these components, or components of subcomponents thereof (e.g., one or more processors, one or more memories), may communicate, directly or indirectly, with one another (e.g., via one or more buses).

The transmission component 525 may be configured as or otherwise support a means for transmitting an indication of a set of LBAs for storing metadata associated with management of a file system. In some examples, the transmission component 525 may be configured as or otherwise support a means for transmitting data associated with a first LBA after transmitting the indication of the set of LBAs for storing metadata, where the first LBA is included in the set of LBAs. The read component 530 may be configured as or otherwise support a means for transmitting a command to read the first LBA. In some examples, the read component 530 may be configured as or otherwise support a means for receiving, in response to the command, the data in response to the first LBA being included in the set of LBAs.

In some examples, the indication of the set of LBAs indicates a plurality of starting LBAs for respective data regions of a plurality of data regions associated with the file system.

In some examples, the plurality of data regions associated with the file system includes a first data region associated with a checkpoint, a second data region associated with a segment information table, a third data region associated with a node address table, and a fourth data region associated with a segment summary area.

In some examples, the transmission component 525 may be configured as or otherwise support a means for transmitting an indication of a region of LBAs for storing user data after transmitting the set of LBAs for storing metadata.

In some examples, the transmission component 525 may be configured as or otherwise support a means for transmitting a command associated with writing second data to a second LBA within the region of LBAs for storing user data after transmitting the indication of the second LBA. In some examples, the transmission component 525 may be configured as or otherwise support a means for transmitting a command to read the second LBA. In some examples, the read component 530 may be configured as or otherwise support a means for receiving, responsive to the command, the second data in response to transmitting the command to read the second LBA.

In some examples, to support transmitting the indication of the set of LBAs, the transmission component 525 may be configured as or otherwise support a means for transmitting a vendor-unique command, an attribute, a flag, or a combination thereof, indicating the set of LBAs.

In some examples, to support transmitting the indication of the set of LBAs for storing metadata, the transmission component 525 may be configured as or otherwise support a means for transmitting an indication of a range of contiguous LBAs for storing metadata.

In some examples, the management component 535 may be configured as or otherwise support a means for determining the set of LBAs for storing metadata associated with management of the file system in accordance with one or more properties of the file system.

In some examples, the file system is a F2FS.

In some examples, the described functionality of the host system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 520, or various components thereof, may be implemented at least in part by instructions (e.g., stored in memory, non-transitory computer-readable medium) executable by such at least one processor.

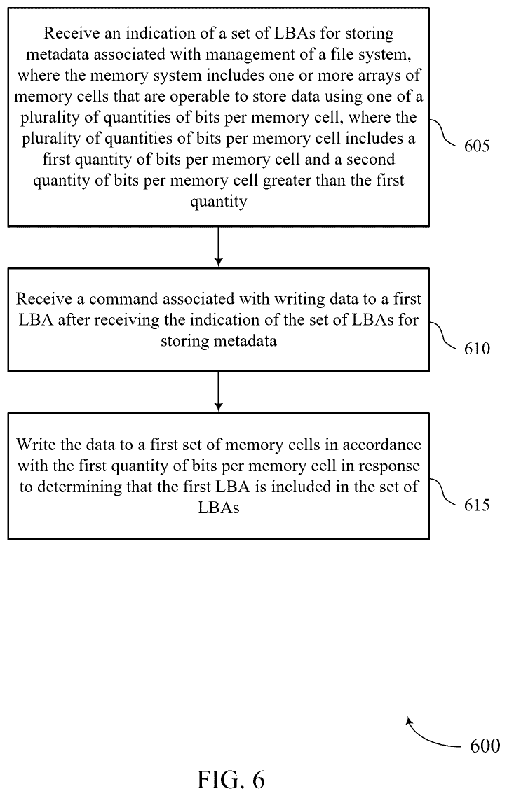

FIG. 6 shows a flowchart illustrating a method 600 that supports file system metadata storage in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include receiving an indication of a set of LBAs for storing metadata associated with management of a file system, where the memory system includes one or more arrays of memory cells that are operable to store data using one of a plurality of quantities of bits per memory cell, where the plurality of quantities of bits per memory cell includes a first quantity of bits per memory cell and a second quantity of bits per memory cell greater than the first quantity. In some examples, aspects of the operations of 605 may be performed by a reception component 425 as described with reference to FIG. 4.

At 610, the method may include receiving a command associated with writing data to a first LBA after receiving the indication of the set of LBAs for storing metadata. In some examples, aspects of the operations of 610 may be performed by a command component 430 as described with reference to FIG. 4.

At 615, the method may include writing the data to a first set of memory cells in accordance with the first quantity of bits per memory cell in response to determining that the first LBA is included in the set of LBAs. In some examples, aspects of the operations of 615 may be performed by a write component 435 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving an indication of a set of LBAs for storing metadata associated with management of a file system, where the memory system includes one or more arrays of memory cells that are operable to store data using one of a plurality of quantities of bits per memory cell, where the plurality of quantities of bits per memory cell includes a first quantity of bits per memory cell and a second quantity of bits per memory cell greater than the first quantity; receiving a command associated with writing data to a first LBA after receiving the indication of the set of LBAs for storing metadata; and writing the data to a first set of memory cells in accordance with the first quantity of bits per memory cell in response to determining that the first LBA is included in the set of LBAs.

Aspect 2: The method, apparatus, or non-transitory computer-readable medium of aspect 1, where the indication of the set of LBAs indicates a plurality of starting LBAs for respective data regions of a plurality of data regions associated with the file system.

Aspect 3: The method, apparatus, or non-transitory computer-readable medium of aspect 2, where the plurality of data regions associated with the file system includes a first data region associated with a checkpoint, a second data region associated with a segment information table, a third data region associated with a node address table, and a fourth data region associated with a segment summary area.

Aspect 4: The method, apparatus, or non-transitory computer-readable medium of any of aspects 1 through 3, further including operations, features, circuitry, logic, means, or instructions, or any combination thereof for receiving an indication of a region of LBAs for storing user data.

Aspect 5: The method, apparatus, or non-transitory computer-readable medium of aspect 4, further including operations, features, circuitry, logic, means, or instructions, or any combination thereof for receiving, after receiving the indication of the region of LBAs for storing user data, a command associated with writing second data to a second LBA within the region of LBAs for storing user data and writing the second data to a second set of memory cells in accordance with the second quantity of bits per memory cell in response to receiving the command and receiving the indication of the region of LBAs for storing user data.

Aspect 6: The method, apparatus, or non-transitory computer-readable medium of any of aspects 1 through 5, where receiving the indication of the set of LBAs includes operations, features, circuitry, logic, means, or instructions, or any combination thereof for receiving a vendor-unique command, an attribute, a flag, or a combination thereof, indicating the set of LBAs.

Aspect 7: The method, apparatus, or non-transitory computer-readable medium of any of aspects 1 through 6, where writing the data to the first set of memory cells includes operations, features, circuitry, logic, means, or instructions, or any combination thereof for writing the data to the first set of memory cells using one bit per memory cell or two bits per memory cell.

Aspect 8: The method, apparatus, or non-transitory computer-readable medium of any of aspects 1 through 7, where receiving the indication of the set of LBAs for storing metadata includes operations, features, circuitry, logic, means, or instructions, or any combination thereof for receiving an indication of a range of contiguous LBAs for storing metadata.

Aspect 9: The method, apparatus, or non-transitory computer-readable medium of any of aspects 1 through 8, further including operations, features, circuitry, logic, means, or instructions, or any combination thereof for moving, after writing the metadata to the first set of memory cells and as part of a maintenance operation, the data from the first set of memory cells to a third set of memory cells associated with the set of LBAs, where the data is written to the third set of memory cells using the first quantity of bits per memory cell.

Aspect 10: The method, apparatus, or non-transitory computer-readable medium of any of aspects 1 through 9, further including operations, features, circuitry, logic, means, or instructions, or any combination thereof for receiving third data associated with the first LBA after receiving the data; writing the third data to a fourth set of memory cells in accordance with the first quantity of bits per memory cell in response to determining that the first LBA is included in the set of LBAs; and erasing the data from the first set of memory cells in response to writing the third data to the fourth set of memory cells.

Aspect 11: The method, apparatus, or non-transitory computer-readable medium of any of aspects 1 through 10, further including operations, features, circuitry, logic, means, or instructions, or any combination thereof for receiving a command to read the data stored to the first LBA and transmitting, responsive to the command, the data from the first set of memory cells.

Aspect 12: The method, apparatus, or non-transitory computer-readable medium of any of aspects 1 through 11, where the file system is a F2FS.

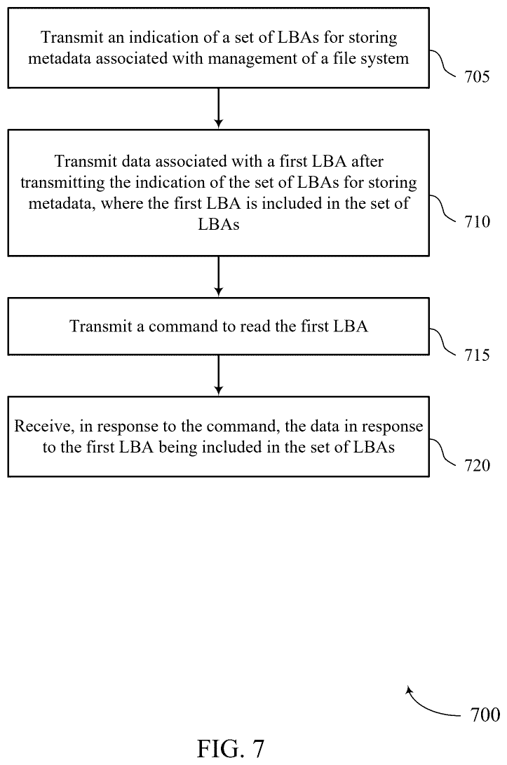

FIG. 7 shows a flowchart illustrating a method 700 that supports file system metadata storage in accordance with examples as disclosed herein. The operations of method 700 may be implemented by a host system or its components as described herein. For example, the operations of method 700 may be performed by a host system as described with reference to FIGS. 1 through 3 and 5. In some examples, a host system may execute a set of instructions to control the functional elements of the device to perform the described functions. Additionally, or alternatively, the host system may perform aspects of the described functions using special-purpose hardware.

At 705, the method may include transmitting an indication of a set of LBAs for storing metadata associated with management of a file system. In some examples, aspects of the operations of 705 may be performed by a transmission component 525 as described with reference to FIG. 5.

At 710, the method may include transmitting data associated with a first LBA after transmitting the indication of the set of LBAs for storing metadata, where the first LBA is included in the set of LBAs. In some examples, aspects of the operations of 710 may be performed by a transmission component 525 as described with reference to FIG. 5.

At 715, the method may include transmitting a command to read the first LBA. In some examples, aspects of the operations of 715 may be performed by a read component 530 as described with reference to FIG. 5.

At 720, the method may include receiving, in response to the command, the data in response to the first LBA being included in the set of LBAs. In some examples, aspects of the operations of 720 may be performed by a read component 530 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 13: A method, apparatus, or non-transitory computer-readable medium including operations, features, circuitry, logic, means, or instructions, or any combination thereof for transmitting an indication of a set of LBAs for storing metadata associated with management of a file system; transmitting data associated with a first LBA after transmitting the indication of the set of LBAs for storing metadata, where the first LBA is included in the set of LBAs; transmitting a command to read the first LBA; and receiving, in response to the command, the data in response to the first LBA being included in the set of LBAs.

Aspect 14: The method, apparatus, or non-transitory computer-readable medium of aspect 13, where the indication of the set of LBAs indicates a plurality of starting LBAs for respective data regions of a plurality of data regions associated with the file system.

Aspect 15: The method, apparatus, or non-transitory computer-readable medium of aspect 14, where the plurality of data regions associated with the file system includes a first data region associated with a checkpoint, a second data region associated with a segment information table, a third data region associated with a node address table, and a fourth data region associated with a segment summary area.

Aspect 16: The method, apparatus, or non-transitory computer-readable medium of any of aspects 13 through 15, further including operations, features, circuitry, logic, means, or instructions, or any combination thereof for transmitting an indication of a region of LBAs for storing user data after transmitting the set of LBAs for storing metadata.

Aspect 17: The method, apparatus, or non-transitory computer-readable medium of aspect 16, further including operations, features, circuitry, logic, means, or instructions, or any combination thereof for transmitting a command associated with writing second data to a second LBA within the region of LBAs for storing user data after transmitting the indication of the second LBA; transmitting a command to read the second LBA; and receiving, responsive to the command, the second data in response to transmitting the command to read the second LBA.

Aspect 18: The method, apparatus, or non-transitory computer-readable medium of any of aspects 13 through 17, where transmitting the indication of the set of LBAs includes operations, features, circuitry, logic, means, or instructions, or any combination thereof for transmitting a vendor-unique command, an attribute, a flag, or a combination thereof, indicating the set of LBAs.

Aspect 19: The method, apparatus, or non-transitory computer-readable medium of any of aspects 13 through 18, where transmitting the indication of the set of LBAs for storing metadata includes operations, features, circuitry, logic, means, or instructions, or any combination thereof for transmitting an indication of a range of contiguous LBAs for storing metadata.

Aspect 20: The method, apparatus, or non-transitory computer-readable medium of any of aspects 13 through 19, further including operations, features, circuitry, logic, means, or instructions, or any combination thereof for determining the set of LBAs for storing metadata associated with management of the file system in accordance with one or more properties of the file system.

Aspect 21: The method, apparatus, or non-transitory computer-readable medium of any of aspects 13 through 20, where the file system is a F2FS.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive an indication of a set of logical block addresses for storing metadata associated with management of a file system, wherein the memory system comprises one or more arrays of memory cells that are operable to store data using one of a plurality of quantities of bits per memory cell, wherein the plurality of quantities of bits per memory cell comprises a first quantity of bits per memory cell and a second quantity of bits per memory cell greater than the first quantity;
receive a command associated with writing data to a first logical block address after receiving the indication of the set of logical block addresses for storing metadata; and
write the data to a first set of memory cells in accordance with the first quantity of bits per memory cell in response to determining that the first logical block address is included in the set of logical block addresses.

2. The memory system of claim 1, wherein the indication of the set of logical block addresses indicates a plurality of starting logical block addresses for respective data regions of a plurality of data regions associated with the file system.

3. The memory system of claim 2, wherein the plurality of data regions associated with the file system comprises a first data region associated with a checkpoint, a second data region associated with a segment information table, a third data region associated with a node address table, and a fourth data region associated with a segment summary area.

4. The memory system of claim 1, wherein the processing circuitry is further configured to cause the memory system to:
receive an indication of a region of logical block addresses for storing user data.

5. The memory system of claim 4, wherein the processing circuitry is further configured to cause the memory system to:
receive, after receiving the indication of the region of logical block addresses for storing user data, a command associated with writing second data to a second logical block address within the region of logical block addresses for storing user data; and
write the second data to a second set of memory cells in accordance with the second quantity of bits per memory cell in response to receiving the command and receiving the indication of the region of logical block addresses for storing user data.

6. The memory system of claim 1, wherein receiving the indication of the set of logical block addresses comprises the processing circuitry configured to cause the memory system to:
receive a vendor-unique command, an attribute, a flag, or a combination thereof, indicating the set of logical block addresses.

7. The memory system of claim 1, wherein writing the data to the first set of memory cells comprises the processing circuitry configured to cause the memory system to:
write the data to the first set of memory cells using one bit per memory cell or two bits per memory cell.

8. The memory system of claim 1, wherein receiving the indication of the set of logical block addresses for storing metadata comprises the processing circuitry configured to cause the memory system to:
receive an indication of a range of contiguous logical block addresses for storing metadata.

9. The memory system of claim 1, wherein the processing circuitry is further configured to cause the memory system to:
move, after writing the metadata to the first set of memory cells and as part of a maintenance operation, the data from the first set of memory cells to a third set of memory cells associated with the set of logical block addresses, wherein the data is written to the third set of memory cells using the first quantity of bits per memory cell.

10. The memory system of claim 1, wherein the processing circuitry is further configured to cause the memory system to:
receive third data associated with the first logical block address after receiving the data;
write the third data to a fourth set of memory cells in accordance with the first quantity of bits per memory cell in response to determining that the first logical block address is included in the set of logical block addresses; and
erase the data from first set of memory cells in response to writing the third data to the fourth set of memory cells.

11. The memory system of claim 1, wherein the processing circuitry is further configured to cause the memory system to:
receive a command to read the data stored to the first logical block address; and
transmit, responsive to the command, the data from the first set of memory cells.

12. The memory system of claim 1, wherein the file system is a flash-friendly file system (F2FS).

13. A host system, comprising:
one or more interfaces comprising one or more signal paths operable for communications with one or more memory systems; and
processing circuitry coupled with the one or more interfaces and configured to cause the host system to:
transmit an indication of a set of logical block addresses for storing metadata associated with management of a file system;
transmit data associated with a first logical block address after transmitting the indication of the set of logical block addresses for storing metadata, wherein the first logical block address is included in the set of logical block addresses;
transmit a command to read the first logical block address; and
receive, in response to the command, the data in response to the first logical block address being included in the set of logical block addresses.

14. The host system of claim 13, wherein the indication of the set of logical block addresses indicates a plurality of starting logical block addresses for respective data regions of a plurality of data regions associated with the file system.

15. The host system of claim 14, wherein the plurality of data regions associated with the file system comprises a first data region associated with a checkpoint, a second data region associated with a segment information table, a third data region associated with a node address table, and a fourth data region associated with a segment summary area.

16. The host system of claim 13, wherein the processing circuitry is further configured to cause the host system to:
transmit an indication of a region of logical block addresses for storing user data after transmitting the set of logical block addresses for storing metadata.

17. The host system of claim 16, wherein the processing circuitry is further configured to cause the host system to:
transmit a command associated with writing second data to a second logical block address within the region of logical block addresses for storing user data after transmitting the indication of the second logical block address;
transmit a command to read the second logical block address; and
receive, responsive to the command, the second data in response to transmitting the command to read the second logical block address.

18. The host system of claim 13, wherein transmitting the indication of the set of logical block addresses comprises the processing circuitry configured to cause the host system to:
transmit a vendor-unique command, an attribute, a flag, or a combination thereof, indicating the set of logical block addresses.

19. The host system of claim 13, wherein transmitting the indication of the set of logical block addresses for storing metadata comprises the processing circuitry configured to cause the host system to:
transmit an indication of a range of contiguous logical block addresses for storing metadata.

20. The host system of claim 13, wherein the processing circuitry is further configured to cause the host system to:
determine the set of logical block addresses for storing metadata associated with management of the file system in accordance with one or more properties of the file system.

21. The host system of claim 13, wherein the file system is a flash-friendly file system (F2FS).

22. A non-transitory computer-readable medium storing instructions which, when executed by one or more processors of a memory system, cause the memory system to:
receive an indication of a set of logical block addresses for storing metadata associated with management of a file system, wherein the memory system comprises one or more arrays of memory cells that are operable to store data using one of a plurality of quantities of bits per memory cell, wherein the plurality of quantities of bits per memory cell comprises a first quantity of bits per memory cell and a second quantity of bits per memory cell greater than the first quantity;
receive a command associated with writing data to a first logical block address after receiving the indication of the set of logical block addresses for storing metadata; and
write the data to a first set of memory cells in accordance with the first quantity of bits per memory cell in response to determining that the first logical block address is included in the set of logical block addresses.

23. The non-transitory computer-readable medium of claim 22, wherein the indication of the set of logical block addresses indicates a plurality of starting logical block addresses for respective data regions of a plurality of data regions associated with the file system.

24. The non-transitory computer-readable medium of claim 23, wherein the plurality of data regions associated with the file system comprises a first data region associated with a checkpoint, a second data region associated with a segment information table, a third data region associated with a node address table, and a fourth data region associated with a segment summary area.

25. The non-transitory computer-readable medium of claim 22, wherein the instructions are further executable by the one or more processors to:
receive an indication of a region of logical block addresses for storing user data.
